(19) United States
(12) Patent Application Publication
(10) Pub. No.: US 2010/0115739 A1
(43) Pub. Date: May 13, 2010

(54) CLIP WITH HARD AND SOFT GRIPS

(76) Inventor: Anant MATHUR, Medford, MA (US)

Correspondence Address: ANANT MATHUR, APT 624, 55 STATION LANDING, MEDFORD, MA, 02155, US

(21) Appl. No.: 12/558,512

(22) Filed: Sep. 12, 2009

Related U.S. Application Data
(60) Provisional application No. 61/192,103, filed on Sep. 16, 2008.

(51) Int. Cl. A44B 18/00; A44B 99/00; F16B 47/00

(52) U.S. Cl. 24/306; 24/455; 24/303; 24/304

(57) ABSTRACT

A clip for attaching objects e.g. cord to other objects such as clothes is disclosed. The clip mechanism is a combination of a hard grip capable of gripping a rigid or semi-rigid material and a soft grip which can simultaneously accommodate multiple rigid objects of various sizes. The hard grip is comprised of a pinched U-shaped section integral to the clip in which the two abutting members of said U-shape exert elastic pressure upon each other. The soft grip is comprised of a U-shaped section integral to the clip, the inside of which is lined with a compressible, foam-type elastic material.

### CROSS-REFERENCE TO RELATED APPLICATIONS

Continuation to Provisional Patent Application No. 61/192,103 Confirmation Number 9057, Filing Date Sep. 16, 2008

### FIELD OF INVENTION

The present invention relates to clips. More particularly, the present invention is a clip with a soft, foam-lined grip that can accommodate earphone cords and such objects, and a hard resilient grip that attaches to articles such as a user's clothing. The clip is used for securing earphone cords of a portable audio device (PAD) to the user's clothing, thereby creating a point of restraint for the cords.

### BACKGROUND

A typical ‘in-ear’ earphone assembly consists of a main coaxial cord that possesses an audio connector at one end. On the other end, said main cord bifurcates into two separate coaxial cords, each of which is connected to a unique earphone. During normal use, the earphones are lodged in the outer part of the user's ear canal, and the main earphone cord is connected to the PAD. The earphone cord assembly remains suspended between the ear and the PAD. The shape of the typical human outer ear is expected to confine the earphone within the ear and prevent it from falling out.

It is observed that earphones are often poorly confined in the user's ears and frequently fall out when the user indulges in physical activity. Since outer ear physiology varies from person to person whereas the earphone shape is standard, many users find that the earphones are a poor fit for them. Even for users who have good physical fit of the earphones in their ears, vigorous motion or a physical activity such as running sometimes causes their earphones to fall out. When this occurs, the earphones plummet to the ground unrestrained, as the cords are nearly 3 feet long and the only remaining point of restraint of the cords is the connection to the PAD, which is most often worn on the user's mid-section.

Clearly, it is a significant inconvenience for the user to retrieve fallen earphones while engaged in physical activity. Sometimes the earphones may be damaged by impact with the ground, and occasionally, the suspended earphone cords become entangled with another moving object or person. The resulting pull from the relative motion of the user and the external object can damage the earphone assembly, or even the PAD. In some cases, the user may suffer physical injury from trying to retrieve the earphones while, say, running on a treadmill and tripping over in the process.

In order to avoid such problems associated with unrestrained earphones, currently users must separately acquire specialized earphone assemblies and wear those in place of the standard earphone assemblies that come pre-packaged with PADs. These specialized products typically employ individual clips around each earphone where the said clips latch on to the outer ear of the user. Alternatively, other earphone assemblies utilize a connecting bar between the earphones where the said bar wraps around the back of the user's head and holds the earphones in place by applying a compressive force.

Specialized earphone assemblies are expensive and pose a substantial additional cost to the user. Further, many users dislike the aesthetic aspects of these products. As a result most PAD users continue to rely on the standard earphone assemblies supplied along with the PAD by the manufacturers. These earphone assemblies typically do not include any means of restraining the earphones or the earphone cords to the user's person while in use. No easy-to-use and inexpensive devices are currently available that a user can employ in order to secure the earphones assemblies to their person.

### DISCUSSION OF PRIOR ART

A conventional cord clip, as illustrated in FIG. 6, typically consists of an alligator clip type spring-loaded latch that grips clothing, and a hook-type annular slot through which the cord is passed and in which said cord is restrained. The conventional cord clip has several limitations. First, it consists of several individual components that must be manufactured separately and subsequently assembled. This results in high total cost of the device.

Second, because the typical earphone cord is thin and the cord-holding portion of the device is small, it is rather difficult to insert the cord into said cord-holding portion. It is equally difficult to remove the cord from the device, if so desired by the user.

Third, because the grip of the cord-holding portion is rigid and inflexible in nature, it can accommodate only one particular size (or a very narrow range of sizes) of diameter of cord. A cord that is thicker than the smallest inside dimension of the cord-holding portion cannot be inserted into the clip, and while a thinner cord can be inserted, it is not held in place by friction. Indeed, said thinner cord may unintentionally de-attach from the device due to even small forces acting upon it during regular use, thereby defeating the very purpose of the clip.

Finally, owing to the fixed and narrow shape of the cord-holding portion, it is very difficult to insert two cords into it. This difficulty arises when a user of an earphone assembly wishes to wear the clip on the upper portion of their body and wish to restrain the two branch cords. Users who indulge in physical activity such as running while wearing earphone assemblies often desire to attach the clip on the neckline of their clothing, where they have to restrain the two branch cords, not one. The conventional cord clip is very difficult to use in this application.

The invention of Nasu et al. U.S. Pat. No. 6,526,635 B2 improved upon the above conventional cord clip by introducing an integral mechanism that did not require assembly and was therefore relatively less expensive. However, the Nasu clip did not address the other fundamental problems with the conventional cord clip. First, like the conventional clip, the Nasu clip is also difficult to use because cords are usually thin and it requires some degree of effort to insert or remove the cords from the annular cord holding portion of the Nasu clip.

Second, because the annular cord-holding portion of the Nasu clip is of rigid construction similar to the conventional cord clip, the Nasu clip can accommodate only a fixed (or within a narrow range) diameter of cord. Also, for similar reasons as discussed for the conventional cord clip, it is difficult to attach more than one cord simultaneously to the Nasu clip.

Prior art includes versions of S-shaped clips for holding sunglasses, pencils, and such items. However, none of these inventions can be used for restraining earphone cords with the desired ease and flexibility.

A conventional S-shaped clip may be considered as composing of two integrated anti-parallel U-shapes, each used as a grip. In all prior art, the object gripping U-shape consists of two flat, rigid members pushed against each other by an elastic force generated by the semi-cylindrical zone that connects the two members i.e. the curved bottom of the “U”. By necessity of this design, when a cylindrical cord having diameter smaller than the diameter of the semi-cylindrical portion of the U-shape is inserted into the U-shape, it is easily possible for the cord to slip towards the semi-cylindrical end of the U-shape. When this occurs, the cord is no longer gripped by the device and becomes free to move longitudinally along its axis, even as it remains laterally constrained. Thus the gripping action of the device is compromised.

On the other hand, if a cord of diameter larger than the diameter of the semi-cylindrical end of the U-shape is inserted between the gripping members, it does become firmly gripped by the device. However, this causes the flat gripping members to become non-parallel to each other and therefore a second cord having the same diameter as the first one cannot simultaneously be gripped by the U-shape while the said first cord is held in place. Thus, a standard S-shaped clip would not accommodate the plurality of cord sizes typically seen in earphone assemblies in the market, nor the desire of users to clip two earphone cords at the same time.

### BRIEF SUMMARY OF THE INVENTION

In view of the difficulties encountered with the tendency of earphone assemblies to fall out of the users' ears and the potential for damage and injury, there is therefore a need for a device that can grip earphone cords and restrain them from falling to the ground or otherwise becoming suspended solely from the user's PAD.

There is also a need for such a device to be capable of being used interchangeably with different types of earphone assemblies that a user might have.

There is also a need for such a device to be easily adjustable, so that if it is used to restrain the two branch cords of an earphone assembly, the length of each of the said cords can be independently adjusted.

There is also a need for such a device to not cause any damage to the cords during repeated insertion, use, or removal.

There is also a need for such a device to be inexpensive and easy to use.

These and other needs are satisfied by the device of the present invention which comprises of a soft-grip that holds earphone cords, and a hard-grip that is attached to the user's clothing.

As will be appreciated, the invention is capable of other and different embodiments, and its several details are capable of modifications in various respects, all without departing from the invention. Accordingly, the drawings and description are to be regarded as illustrative in nature and not restrictive.

### BRIEF DESCRIPTION OF THE SEVERAL VIEWS OF THE DRAWING

FIG. 1 is a perspective view of a clip with hard and soft grips of the present invention;

FIG. 2 is a front view of a clip with hard and soft grips of FIG. 1;

FIG. 3 is an exploded view of a clip with hard and soft grips of the present invention;

FIG. 4 is a perspective view of a clip with hard and soft grips of the present invention that illustrates how earphone cords are secured; and

FIG. 5 is a view of typical use of a clip with hard and soft grips of the present invention.

### DETAILED DESCRIPTION OF THE INVENTION

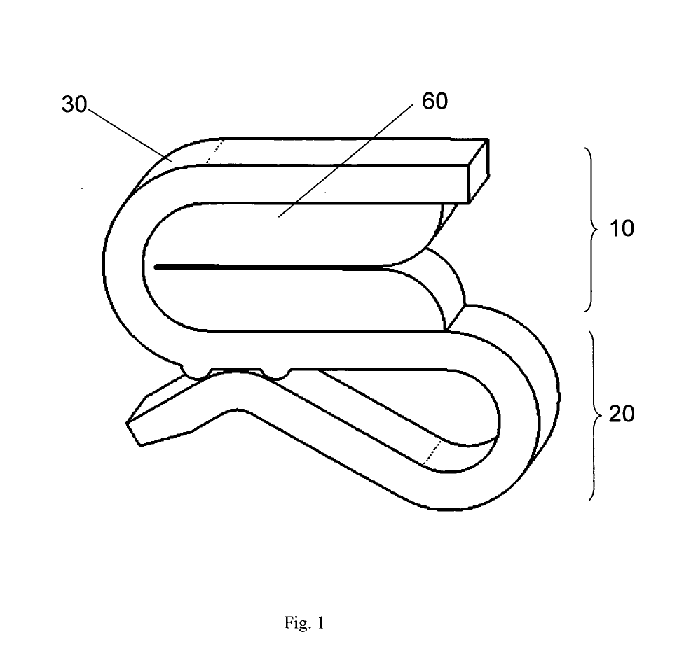

Referring now to the invention in more detail, in FIG. 1 there is shown the drawing of clip with soft and hard grips. In the orientation shown, the top half 10 of the device constitutes the soft-grip section and the bottom half 20 constitutes the hard-grip section. The two main components of the invention are, (1) a rigid frame 30 of serpentine shape, and (2) a foam shape 60 that is attached to and enclosed inside the rigid frame 30.

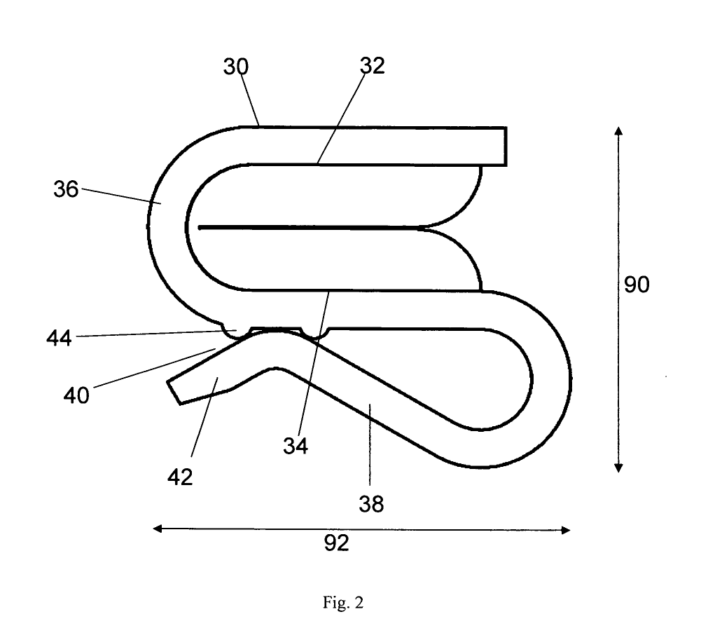

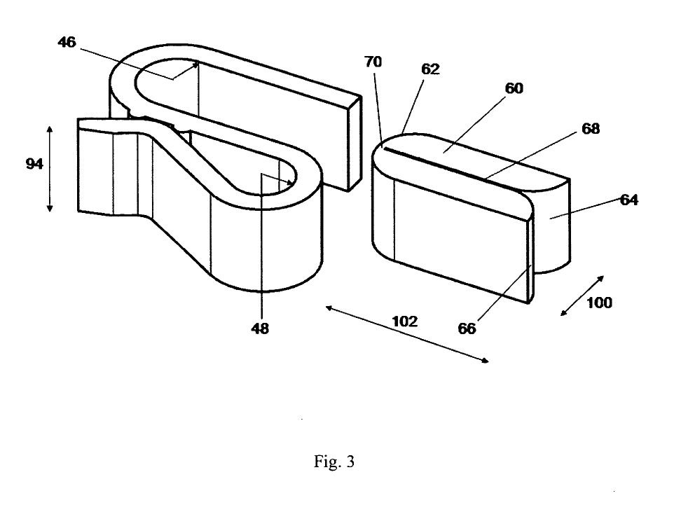

In more detail, and referring now to FIG. 2, there is shown the rigid frame 30 which is in the shape of the letter “S”. In the orientation shown, the top section of the rigid frame 30 has two parallel members 32 and 34 connected by a semi-cylindrical section 36. The bottom section of the rigid frame 30 has a pinched U-shape construction wherein the member 38 is bent upward so that it impinges upon the member 34.

In further detail, and still referring to FIG. 2, the area of contact between member 38 and member 34 is the “hard-grip zone” 40. The section of the leg 42 extending beyond the hard grip zone is curved away from the frame to form a guide into the hard-grip zone. Elevated corrugation 44 is present on the rigid frame surface in the hard-grip zone 40. The corrugations have smooth, curved surfaces.

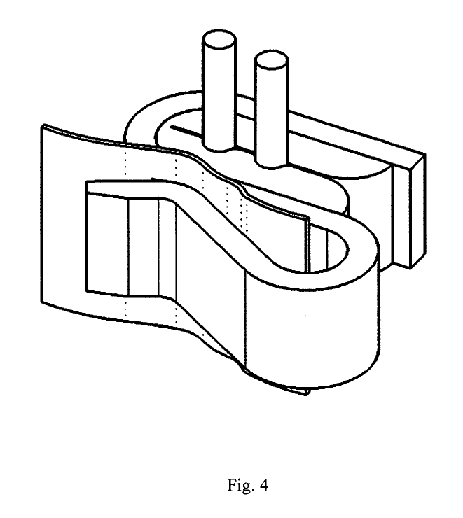

In further detail, and now referring to FIG. 3, there is shown the foam shape 60 that has a rectangular body with flat surfaces but with two ends curved in a particular way. One end of the foam shape 60 has a convex semi-circular surface 62. The other end has two convex quarter-cylindrical surfaces 64 and 66. The foam shape 60 is cut through its middle in the manner shown, resulting in a slot 68. The cut extends completely through the width 104 of the foam shape, but a small portion 70 is left uncut. The cut creates a substantial foam-foam interface.

In further detail, and still referring to FIG. 3, the rigid frame 30 is made of a sufficiently rigid material such as a plastic or a metal. The frame must be of an appropriate size so that the device is easy to handle for the user and yet inconspicuous when worn on clothing. Hence in the present manifestation, the height 90 of the frame is about 9 mm, the length dimension 92 of the frame is about 12 mm, and the width 94 of the frame is about 4 mm. The radius of curvature of the curved section 46 of the frame is about 4 mm, and the radius of curvature of the loop section 48 is also 4 mm.

In further detail, and still discussing FIG. 3, the foam shape 60 is constructed from a foam material that is compressible but elastic. An example of such a material is synthetic polyethylene foam. In the present manifestation, the length dimension 102 of the foam shape 60 is about 8 mm. The width dimension 104 of the foam shape 60 is equal to or a little less than the width dimension 94 of the rigid frame 30, and is about 3-4 mm. The height dimension 100 of the foam shape 60 is equal to or slightly greater than the separation of the two parallel surfaces 32 and 34.

The invention is completed by assembling the two components, rigid frame 30 and foam shape 60. A suitable permanent adhesive is applied to the inside parallel surfaces 32 and 34 of the rigid frame 30, and the foam shape 60 is inserted between them to obtain the completed form shown in FIG. 1. The adhesive is allowed to cure for an appropriate period of time.

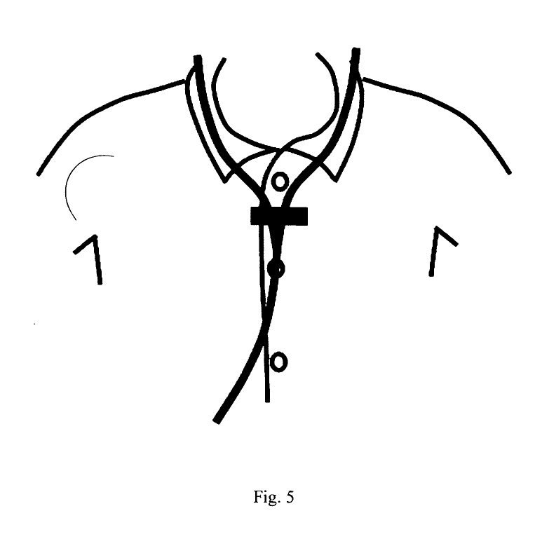

Referring now to FIG. 4, there is shown an illustration of how the device of the present invention is used for restraining earphone cords. The user's earphone cords are slid into the soft-grip section 10 of the invention by pushing said cords into the tapered opening between the top and bottom sections of the foam shape 60, where the said tapered opening serves as in insertion guide. Once the cords are inserted in slot 68 of the foam shape 60, they are held in place by the compressive force of the foam and friction between the cord insulation and the foam, and can only be removed by a pulling action of relatively significant force.

Still referring to FIG. 4, there is also shown how the device of the present invention is worn on clothing. An edge of the user's clothing material is slid into the hard-grip section 20 of the invention by pushing said edge into the tapered opening and through the hard-grip zone 40. Once the cloth material is inserted into the corrugated interface in the hard-grip zone 40, the compressive force acting on the cloth and the friction between the cloth and frame surfaces allow the device of the present invention to grip the cloth with adequate force. The corrugations on the surfaces in the hard-grip zone allow enhanced gripping area on the cloth, thereby providing improved gripping action.

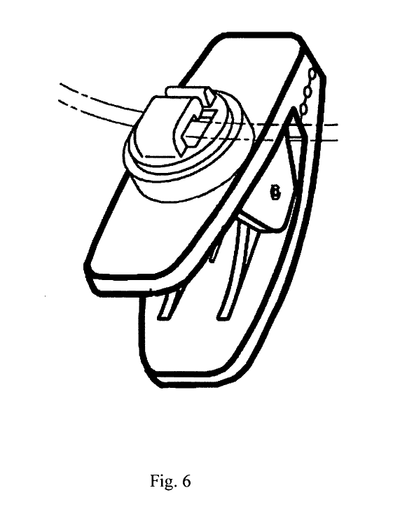

Referring now to FIG. 5, there is shown an illustration of how the device of the present invention may he used by the PAD user. The invention is mounted on the placket-front of the user's shirt and the earphone cords are passed through and secured by the soft-grip of the invention. If the earphones fall out of the user's ears, they remain suspended from the present invention, only about 15 cm or so away from the user's ears and are easily retrieved by the user. The invention may, of course, be worn on any part of the user's clothing, such as the breast pocket, the collar etc.

As described hereinabove, the present invention solves several problems associated with PAD earphone use. The advantages of the present invention include, without limitation, avoiding the inconvenience of fallen earphones, avoiding potential damage to the user's PAD, and avoiding the possibility of injury to the user that may otherwise result when the user trips over unrestrained earphones. The materials and process required to make the present invention are simple and inexpensive, hence the invention will be easily affordable to users.

While an illustrative and presently preferred embodiment of the present invention has been described in detail herein, it is to be understood that the inventive concepts may be otherwise variously embodied and employed and the appended claims are intended to be construed to include such variations except insofar as limited by prior art.

What is claimed is:

1. A clip comprising:
a soft grip that is formed by a U-shape wherein the inner surface of said U-shape is lined with a compressible elastic material and a gripping action is generated by the compressive force of said elastic material and friction with the object inserted between the abutting elastic material surfaces;
a hard grip that is formed from a pinched U-shape wherein the gripping action is generated by the compressive force between the abutting members of said pinched U-shape;

2. A clip according to claim 1 in which the abutting surfaces of the hard grip are variously corrugated, serrated or otherwise made rough in order to enhance friction and thereby improve the gripping action;

3. A clip according to claim 1 but of larger dimensions than those described in this application so that the hard grip may accommodate thicker objects (such as overhanging table edges) and the soft grip may accommodate larger objects such as screwdrivers, scissors, pens and such;

4. A clip according to claim 1 but of smaller dimensions than those herein described so that the hard grip may accommodate thinner objects (such as paper sheets) and the soft grip may accommodate smaller objects such as paper sheets, photographs and such;

5. A clip according to claim 1 where the dimensions of the hard and soft grip are unequally scaled so that one is larger or smaller than the other;

6. A clip comprising:
a soft grip that is formed by a U-shape wherein the inner surface of said U-shape is lined with a compressible elastic material and a gripping action is generated by the compressive force of said elastic material and friction with the object inserted between the abutting elastic material surfaces;
a hard grip that is formed by attaching a sheet of adhesive, a Velcro fastener, a magnetic pad or other such agent to the outside surface of one of the two members of the soft-grip U-shape in order that it may adhere to a suitable surface;

7. A clip comprising:
a soft grip that is formed by a U-shape wherein the inner surface of said U-shape is lined with a compressible elastic material and a gripping action is generated by the compressive force of said elastic material and friction with the object inserted between the abutting elastic material surfaces;
a hard grip that is formed by a spring-loaded clamp such as those found in conventional cord clips.
